(19) United States
(12) Patent Application Publication
(10) Pub. No.: US 2009/0249457 A1
(43) Pub. Date: Oct. 1, 2009

(54) ACCESSING SECURE NETWORK RESOURCES

(76) Inventors: Bruno Y. Graff, La Rochelle (FR); Christian Pineau, Los Gatos, CA (US); Luc BeAl, Villars les Dombes (FR); Johann J. C. Graff, La Rochelle (FR); Sylvain P. A. Doyen, Le Mans (FR)

Correspondence Address: FISH & RICHARDSON P.C., PO BOX 1022, MINNEAPOLIS, MN, 55440-1022, US

(21) Appl. No.: 12/410,270

(22) Filed: Mar. 24, 2009

Related U.S. Application Data
(60) Provisional application No. 61/039,206, filed on Mar. 25, 2008.

(51) Int. Cl. H04L 9/32; H04L 29/06; G06F 15/173

(52) U.S. Cl. 726/6; 709/228

(57) ABSTRACT

The disclosed implementations generally provide a user access to a secure network resource (e.g., a website, chat application). In some implementations, access to a secure network resource is provided by a communication terminal in communication with a secure access service. The communication terminal detects a presence of a unique identifier (e.g., a Bluetooth MAC address stored in a mobile device), and passes the unique identifier and cryptographic information (e.g., a key code or digital certificate) to the secure access service. The secure access service validates the integrity of the unique identifier and authenticates the user of the device by reading the cryptographic information (e.g., reading the certificate).

### RELATED APPLICATIONS

This application claims the benefit of U.S. Provisional Patent Application No. 61/039,206, filed Mar. 25, 2008, which provisional patent application is incorporated by reference herein in its entirety.

This application is related to International Application No. PCT/FR2007/051157, for “Monitoring For the Presence of a Radio-Communicating Module in the Vicinity A Radio-Communicating Terminal,” filed Apr. 23, 2007, which International Application is incorporated by reference herein in its entirety.

### TECHNICAL FIELD

This subject matter is generally related to data communications between electronic devices.

### BACKGROUND

Conventional solutions for obtaining access to secure network resources (e.g., websites, chat application) require a user to provide a login ID and password. The login ID and password are verified by the network resource, and upon successful verification of the device, the user is allowed access to the network resource. These conventional solutions, however, cannot guarantee that the user attempting to access the network resource is the owner of the login ID and password.

### SUMMARY

The disclosed implementations generally provide a user access to a secure network resource (e.g., a website, chat application). In some implementations, access to a secure network resource is provided by a communication terminal in communication with a secure access service. The communication terminal detects a unique identifier (e.g., a Bluetooth MAC address stored in a mobile device), and passes the identifier and cryptographic information (e.g., a key code or digital certificate) which is linked to the unique identifier) to the secure access service. The secure access service validates the integrity of the unique identifier and authenticates the user of the device by reading the cryptographic information (e.g., reading the certificate).

In some implementations, the unique identifier is personalized by an encrypted certificate generated during a preliminary registration procedure implemented by an authentication server. During the preliminary registration procedure, the authentication server generates an information request (e.g., a questionnaire) and sends the request to the communication terminal. The user can provide the requested information (e.g., a filled in questionnaire) through one or more user interfaces (e.g., web pages) provided by the authentication server or a dedicated web page server. For example, the user interface can be a web page served by the dedicated web page server and displayed in a browser running on the communication terminal and/or the device. In some implementations, the requested information can include user characteristics, including but not limited to: age, country, gender, data of birth, etc., which can be certified by official elements, including but not limited to: a social security number, a telephone service contract, a password, etc. The authentication server generates cryptographic information (e.g., a key code or digital certificate) using the requested information and the unique identifier. The cryptographic information is sent to the communication terminal. The cryptographic information can be stored on the device and/or the communication terminal.

In some implementations, the communication terminal and device can use radio detection technology (e.g., Bluetooth, Wi-Fi) to detect the unique identifier. A transmission range can be manually or automatically adjusted so that secure access can only occur while the device is within a specified transmission range (e.g., a user-specified radius or distance) of the communication terminal. When the device is no longer within the specified transmission range, for example, due to moving outside the specified transmission range, the communication session between the communication terminal and the device can be terminated or suspended. Thus, the device (and therefore the user) must be physically present before the communication terminal during the access procedure, and during subsequent communications with the network resource after access has been granted.

Once connected, the user can be provided access to the network resource in accordance with an access control policy. For example, an access control policy generated by a parent may limit their child's access to certain authorized network resources, content or services, while allowing free access to others network resources, content or services. Likewise, a business may limit customers to certain services provided by a corporate website, or an employer may limit employees to certain services provided by a company intranet. In some implementations, the network resource can track and report user activity over a period of time. For example, a parent can track a child's use of the Internet over a specified period of time.

In some implementations, the unique identifier and other personal information is stored in a repository (e.g., a worldwide repository) that can be owned and/or operated by a trusted entity. Access requests made after the preliminary registration process can include validating the requesting device by matching the unique identifier provided by the device with a matching unique identifier stored in the database.

The disclosed implementations can be used to provide persistent and personalized access to secure network resources, such as applications, download sites, web sites or web pages, chat applications, personal pages, email boxes, services, social networks, content repositories, etc. The disclosed implementations allow tracking and reporting of user activity by recording when and where the user attempts to access a network resource.

### DESCRIPTION OF DRAWINGS

FIG. 1 illustrates an example system for accessing a secure network resource.

FIG. 2 is a flow diagram of an example preliminary registration process performed by the communication terminal of FIG. 1 for accessing a secure network resource.

FIG. 3 is a flow diagram of an example preliminary registration process performed by the authentication server of FIG. 1.

FIG. 4 is a flow diagram of an example preliminary registration process performed by the device of FIG. 1 for accessing a secure network resource.

FIG. 5 is a flow diagram of an example access control process performed by the authentication server of FIG. 1 for accessing a secure network resource.

FIG. 6 is a block diagram illustrating an example terminal/device architecture.

FIG. 7 is a block diagram illustrating an example architecture 700 for a secure access service.

### DETAILED DESCRIPTION

### System Overview

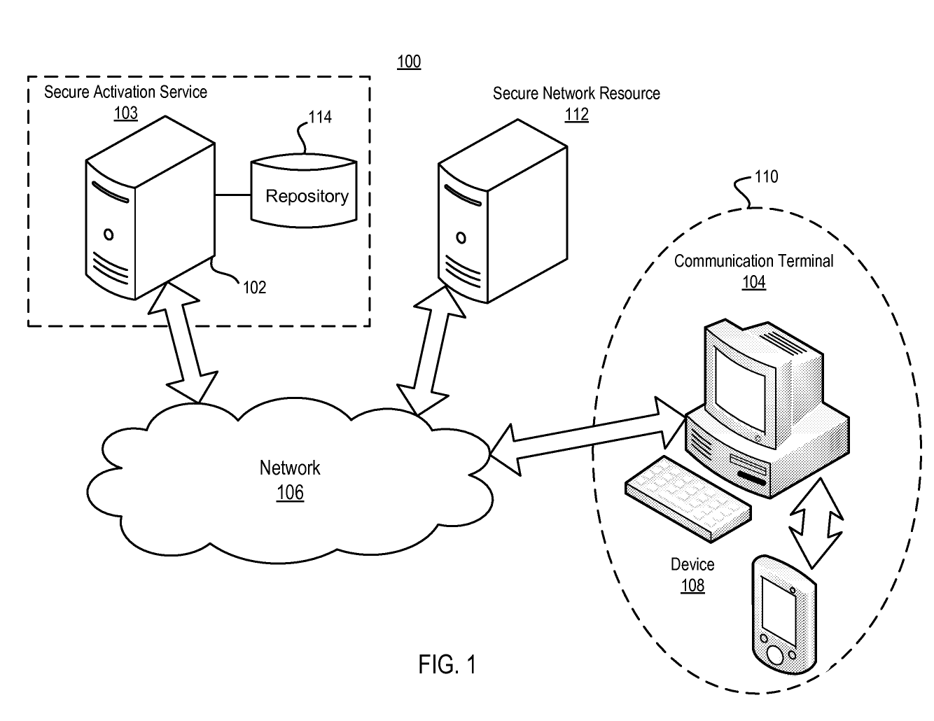

FIG. 1 illustrates an example system 100 for accessing a secure network resource. In some implementations, system 100 can include authentication server 102 and communication terminal 104 coupled to network 106. Device 108 can communicate with communication terminal 104 when communication terminal 104 and device 108 are both located in region 110. The authentication server 102 can be operated by a trusted and secure access service 103.

In some implementations, boundaries of region 110 (indicated by the dashed line) are defined by a transmission range which can be limited by the communication technology deployed. If Bluetooth technology is deployed, the transmission range can be about 10 meters. The transmission range can be adjusted using technology described in International Application No. PCT/FR2007/051157, for “Monitoring For the Presence of a Radio-Communicating Module in the Vicinity A Radio-Communicating Terminal.” The technology covered by this application describes the manual adjustment of transmission range of a Bluetooth-enable device. The technology can be used to detect the presence of device 108 in region 110, and to determine when device 108 travels outside region 110 by analyzing a transmission error rate associated with a test data block.

In some implementations, two or more registered devices 108 need to be physically present within region 110 before access to secure network resource 112 is allowed. An example is a child's wristwatch and a parent's mobile phone, thus ensuring the parent and child carrying or wearing these registered devices are physically present within region 110 before allowing access to secure network resource 112.

In some implementations, device 108 can communicate with communication terminal 104 through a wired or tethered connection, docking station or adapter. In such implementations, the presence of device 108 can be electrically, mechanically or electro-mechanically detected by physically coupling device 108 with communication terminal 104.

Device 108 can be any device capable of communicating with other devices, including but not limited to: personal computers, mobile phones, email readers, media players, game consoles, set-top boxes, personal digital assistants (PDAs), thumb drives, wristwatches and other wearable items, toys, fobs, etc.

Device 108 can be associated with a unique identifier that can be used by authentication server 102 to uniquely identify device 108. The unique identifier can be combined with other security mechanisms (e.g., login ID, password) to access secure network resource 112. Some examples of unique identifiers can include but are not limited to: Bluetooth device address (BD_ADDR), GSM Media Access Control (MAC) address, Wi-Fi MAC address, RFID MAC address, ZIGBEE MAC address, International Mobile Equipment Identity (IMEI), Integrated Circuit Card ID (ICCID), International Mobile Subscriber Identity (IMSI), Mobile Equipment Identifier (MEID) etc.

Communication terminal 104 can be any device capable of providing access to a secure network resource, including but not limited to: any of the devices 108, wireless or cellular access points, hubs, routers, servers, gateways, kiosks, etc. Communication terminal 104 can communicate with device 108 using any known communication protocol. In some implementations, communication terminal 104 and device 108 communicate using Bluetooth technology. Bluetooth is a wireless technology communicating in the 2.45 GHz ISM band and is based on a frequency hopping spread spectrum. Bluetooth has a Master/Slave architecture where one master can control up to 7 active slaves. Each Bluetooth transceiver is allocated a unique 48-bit Bluetooth Device Address (BD_ADDR) based on the IEEE 802.15 standard.

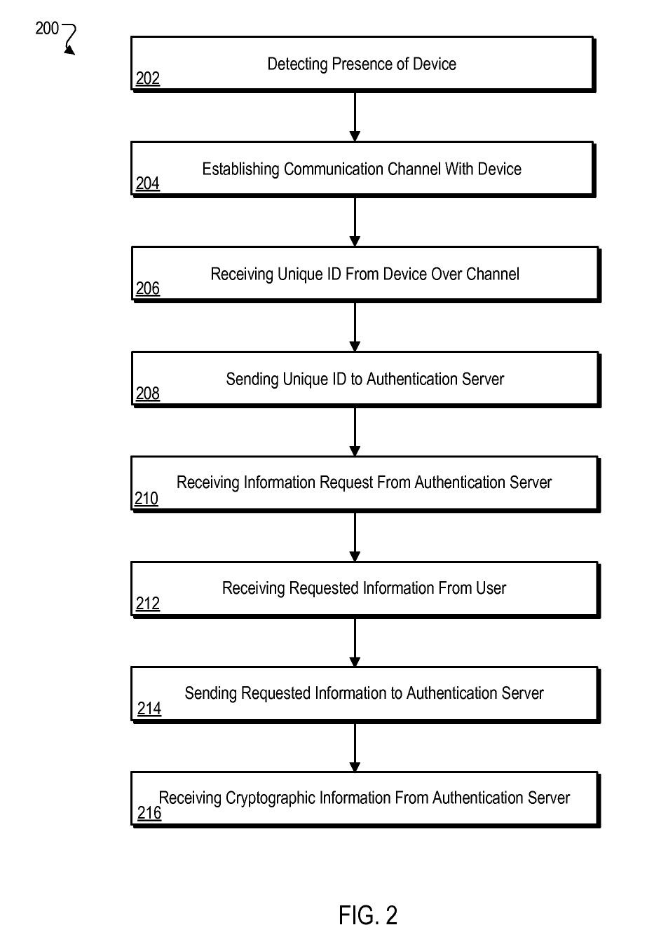

Two Bluetooth devices that want to communicate with each other can use the same frequency hopping sequence, and the Master's BD_ADDR is one of the parameters used in the generation of the hopping sequence. In some implementations, communication terminal 104 can be placed in Inquiry State. While in Inquiry State, communication terminal 104 transmits short ID packages with a predetermined hopping pattern and with a high repetition rate. Device 108 can be placed into Inquiry Scan State or discoverable mode to allow device 108 to be detected by communication terminal 104. Device 108 detects an ID packet and waits a random back-off period (0-2047 time slots) before responding with a Frequency Hop Synchronization (FHS) package. FHS reveals to communication terminal 104 the inquired device's BD_ADDR and clock. The BD_ADDR can be used to access secure network resource 112, as described in FIGS. 2-5.

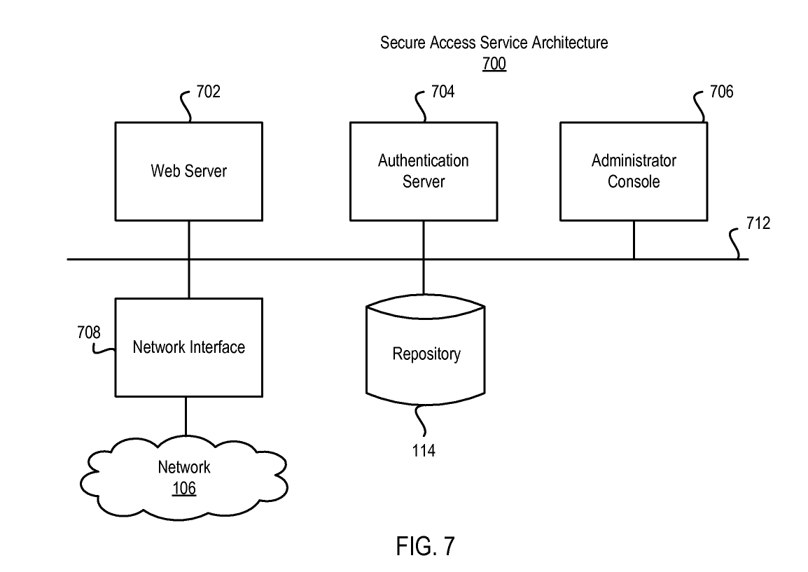

Authentication server 102 can be any device capable of performing an authentication procedure, including but not limited to: a device 108 or communication terminal 104, a server computer, website, etc. Authentication server 102 can be coupled to a repository 114 (e.g., a worldwide database) for persistently storing unique identifiers for devices 108 and other information that can be used for authenticating users of devices 108 (e.g., login ID, password, personal information). The authentication server 102 can be part of a secure access service 103, as described in reference to FIGS. 1 and 7.

In some implementations, to ensure universal data access to secure network resources, the authentication server 102 can include a website to provide a user interface to allow users to enter information. To provide load balancing and/or to avoid the risks and inefficiencies associated with a centralized repository, the website owner can provide access and data entry rights to regional operators or partners around the world who can operate edge servers to provide faster service to regional users. The authentication server 104 and associated website can be owned and operated by a trusted entity (e.g., a government agency).

When selling a device, such as a mobile phone or other Bluetooth-enabled device, a reseller or carrier can request various information from the user and store the information in the repository 114. The information can include but is not limited to: the MAC address or other unique identifier of the device, a cell phone carrier or other service provider information (e.g., AT&T, Orange, Deutsche Telecom, China Telecom), the buyer's month and year of birth and/or other personal information, and in the case of a cell phone, the buyer's cellular telephone number.

Network 106 can include one or more interconnected networks, including but not limited to: the Internet, intranets, LANs, WLANs, cellular networks, ad hoc networks, subnets or piconets, peer-to-peer networks, etc.

Secure network resource 112 can be any network resource capable of providing information, content and/or services. Some examples of secure network resources include but are not limited to: websites, chat applications, e-rooms, intranets, bulletin boards, etc.

In some implementations, when a user requests access to secure network resource 112, the user can be denied access if the unique identifier is not listed in the repository 114, or the unique identifier is listed in the repository 114, but references to personal information (e.g., month and year of birth) do not match cryptographic information required for connection. Access will be granted if the unique identifier is listed in the repository 114 and references to personal information match the cryptographic information.

After access is established with secure network resource 112, communication terminal 104 can monitor device 108 to determine that device 108 is within region 110 (e.g., connected at short-range). The access can be terminated or suspended if device 108 leaves region 110 or when another device that is unauthorized for the current connection enters region 110. This feature ensures that access to secure network resource 112 only persists as long as a single, authorized device 108 is within region 110.

### Example Registration Process

FIG. 2 is a flow diagram of an example preliminary registration process 200 performed by communication terminal 104 of FIG. 1 for accessing a secure network resource 112. In some implementations, the process 200 begins when the presence of a device is detected by a communication terminal (202). The detection can occur within a region defined by the transmission range of the communication technology deployed (e.g., Bluetooth). The transmission range can be manually adjusted using techniques described in International Application No. PCT/FR2007/051157, for “Monitoring For the Presence of a Radio-Communicating Module in the Vicinity A Radio-Communicating Terminal.”

After detection, a communication channel is established with the device (204) and a unique identifier (“ID”) associated with the device is received (206). In some implementations, the communication terminal is a personal computer or other device that connects to the authentication server through a network (e.g., the Internet). The authentication server establishes a communication channel with the communication terminal and requests a wireless signal from the carrier's device (e.g., Bluetooth, Wi-Fi) to authenticate the device's unique ID. The communication terminal securely transfers the device's unique ID to the authentication server using, for example, Internet Protocol version 4 (“IPv4”) and Secure Socket Layer (SSL) protocol. If Bluetooth technology is deployed, the unique ID can be the BD_ADDR of the device which is transmitted to the communication terminal to establish a connection.

The unique ID is sent to an authentication server (208). The communication terminal receives an information request from the authentication server (210). In some implementations, the information request is a questionnaire to be filled out by the user of the device. The requested information (e.g., personal or other information) is received from the user (212). For example, the authentication server (or a separate web server) can serve one or more web pages to the communication terminal which can be used to receive the requested information input by the user. For example, the user can interact with the web page by filling in text boxes with the requested information. The user can be prompted to validate their information to be sure the information was entered correctly. Once the user has validated their information, the user's information can be encrypted or otherwise secured on the communication terminal.

After the requested information is received and secured by the communication terminal, the communication terminal sends the secured information to the authentication server (214). The authentication server creates and allocates cryptographic information (e.g., a secure and unique key code or digital certificate) and directly links the cryptographic information to the unique ID associated with the device. This cryptographic information can be transmitted to the device either through Short Message Service (SMS) or online through a secure website. The communication terminal receives the cryptographic information from the authentication server (216).

The process 200 described above is an example process. Other processes are possible that contain more or fewer steps, or steps that are performed in parallel by two or more processors or processing cores.

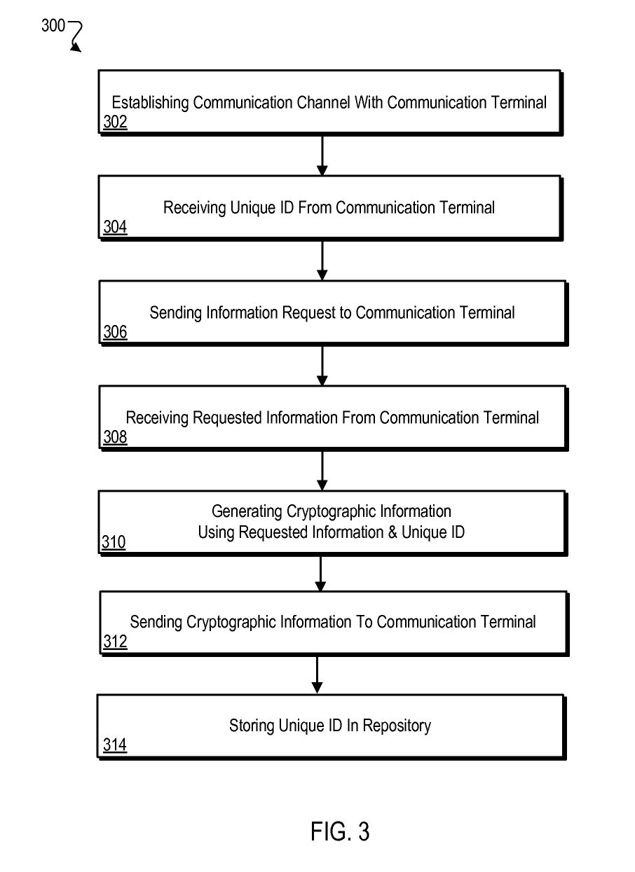

FIG. 3 is a flow diagram of an example preliminary registration process 300 performed by the authentication server 102 of FIG. 1. In some implementations, the process 300 begins by establishing a communication channel with a secure communication terminal (302). The secure communication channel can be implemented using known communication protocols (e.g., IPv4, HTTP, SSL, TLS). Once the communication channel is established, the authentication server receives a unique ID from the communication terminal (304).

The authentication server generates a questionnaire to be filled in by the user and sends the questionnaire to the communication terminal (306). In some implementations, the questionnaire can be a web page which can be viewed by the user through a browser running on the communication terminal. The questionnaire requests personal or any other information that can be used to authenticate the user. The authentication server receives the completed questionnaire from the communication terminal (308).

The authentication server generates cryptographic information (e.g., a key code or digital certificate) using some or all of the requested information and the unique ID (310). In some implementations, some or all of the requested information is used to generate a digital certificate that can be digitally signed. For example, the user's birth date and year and the Unique ID can be input to a known cryptographic hash function (e.g., SHA-1, MD5). The resulting output can be digitally signed with a private key using known a digital certificate standard (e.g., ITU-T X.509).

After the cryptographic information is generated, the cryptographic information is sent to the communication terminal over the secure communication channel (312). In some implementations, the cryptographic information is stored in a repository accessible by the authentication server (314). For example, the repository can be located in one or more of the device 108, authentication server 102 and communication terminal 104.

The process 300 described above is an example process. Other processes are possible that contain more or fewer steps, or steps that are performed in parallel by two or more processors or processing cores.

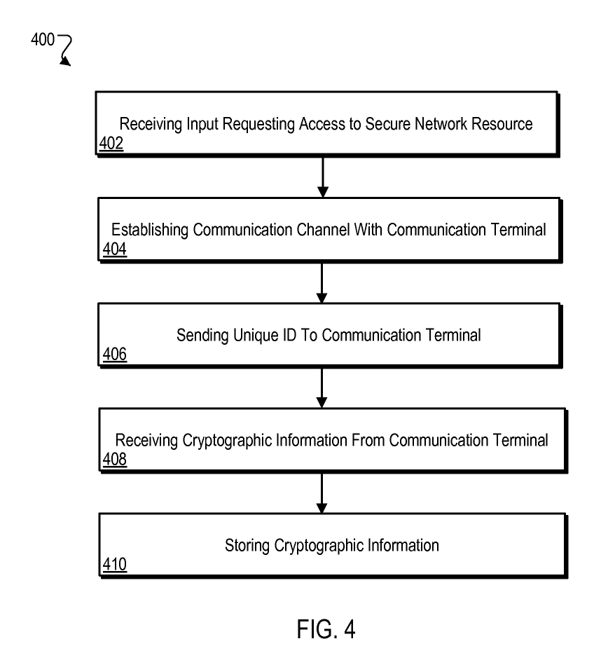

FIG. 4 is a flow diagram of an example registration process 400 performed by the device 108 of FIG. 1 for accessing a secure network resource 112. In some implementations, the process 400 begins when the device receives input from the user or an application running on the device, requesting access to a secure network (402). The request can initiate a discovery mode in the device which will allow a communication terminal to detect the presence of the device. Once detected by the communication terminal, the device and the communication terminal can establish a secure communication channel (404). The device sends the communication terminal its unique ID over the communication channel (406).

The device receives cryptographic information from the communication terminal (408) and stores the cryptographic information locally (410) (e.g., stored in local non-volatile memory). In some implementations, the cryptographic information can also be stored on the authentication server 102 or other remote device. The cryptographic information can be input to the device 108 using a keyboard or touch screen, for example. The cryptographic information can be provided to the authentication server 102 through a communication link or channel (e.g., a GSM connection) with validation and installation performed using SMS, MMS or email with or without assistance of a call center.

The process 400 described above is an example process. Other processes are possible that contain more or fewer steps, or steps that are performed in parallel by two or more processors or processing cores.

### Example Access Control Process

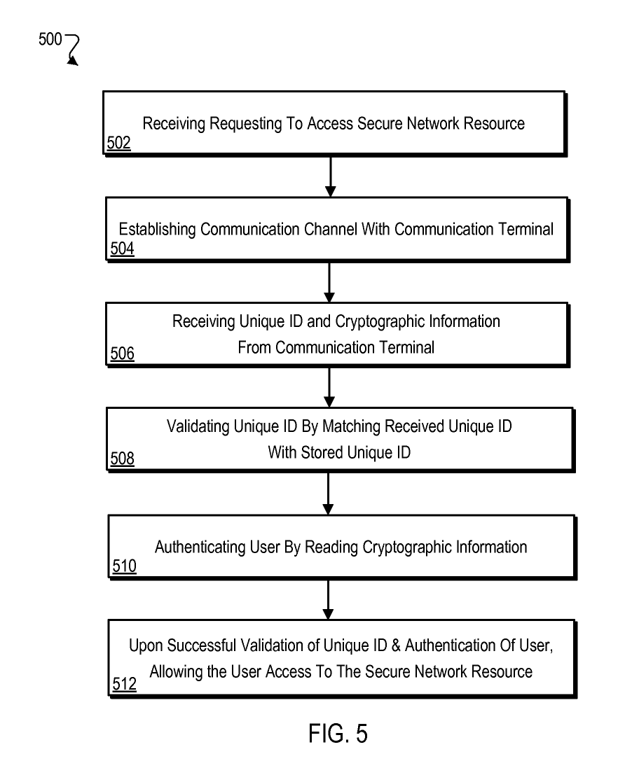

FIG. 5 is a flow diagram of an example access control process 500 performed by the authentication server 102 of FIG. 1 for accessing a secure network resource 112. In some implementations, the process 500 begins when the authentication server receives a request to access a secure network resource from a communication terminal (502). Responsive to this request, a secure communication channel is established between the authentication server and the communication terminal (504). The communication terminal sends the authentication server a unique ID associated with a detected device and cryptographic information associated with a user of the detected device (506).

Responsive to receipt of the unique ID, the authentication server validates the unique ID by comparing the unique ID with stored unique IDs to find a match (508). If a match is found and the unique ID is validated, the authentication server authenticates the user of the device by reading the cryptographic information (510). Upon successful validation of the unique ID and successful authentication of the user, the device and/or communication terminal are allowed access to the secure network resource (512). Thus, the unique ID identifies the device and the unique ID and cryptographic information identify the user. Both the device and the user are identified prior to allowing the user access to the secure network resource. In some implementations, additional security mechanisms can be used after secure access has been granted, such as requiring the user to enter a personal identification number (PIN), answering predetermined questions or entering words, codes or other information presented on a web page.

Once connected, the user can be provided access to the secure network resource in accordance with an access control policy. For example, an access control policy generated by a parent may limit their child's access to certain authorized network resources, content or services, while allowing free access to others network resources, content or services. Likewise, a business may limit customers to certain services provided by a corporate website, or an employer may limit employees to certain services provided by a company intranet. The access control policy can be created by a user through a suitable web page served by the secure access service.

In some implementations, the secure access service can track and report user activity over a period of time. For example, a parent can track a child's use of the Internet over a specified period of time and email a report summarizing the activity.

The process 500 described above is an example process. Other processes are possible that contain more or fewer steps, or steps that are performed in parallel by two or more processors or processing cores.

### Example Terminal/Device Architecture

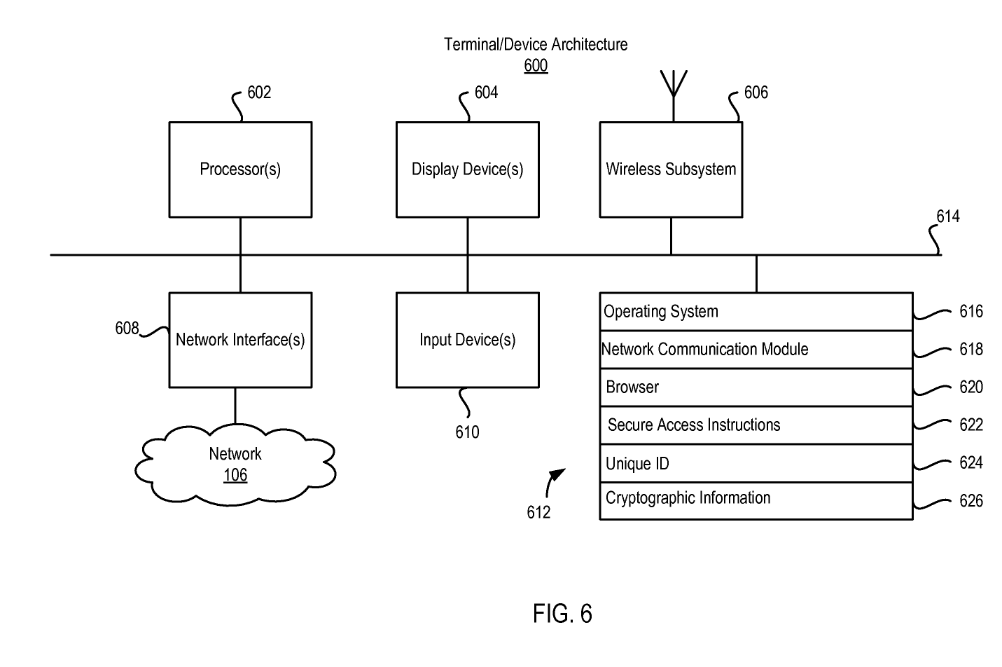

FIG. 6 is a block diagram illustrating an example terminal/device architecture 600. In some implementations, the communication terminal and the device are personal computers having an architecture 600. The architecture 600 is an example architecture and other architectures are possible, including architectures having more or fewer components.

The architecture 600 generally includes one or more of: processors or processing cores 602 (e.g., Intel Core 2 Duo processors), display devices 604 (e.g., an LCD) and input devices 610 (e.g., mouse, keyboard, touch pad). The architecture 600 can include a wireless subsystem 606 for wireless communications (e.g., a Bluetooth wireless transceiver) and one or more network interfaces 608 (e.g., USB, Firewire, Ethernet) for wired communications. The communication terminal and device include various computer-readable mediums 612, including without limitation volatile and non-volatile memory (e.g., RAM, ROM, flash, hard disks, optical disks). These components exchange data, address and control information over one or more communication channels or busses 614 (e.g., EISA, PCI, PCI Express).

The term “computer-readable medium” refers to any medium that participates in providing instructions to a processor 602 for execution, including without limitation, non-volatile media (e.g., optical or magnetic disks), volatile media (e.g., memory) and transmission media. Transmission media includes, without limitation, coaxial cables, copper wire and fiber optics. Transmission media can also take the form of acoustic, light or radio frequency waves.

The computer-readable medium 612 further includes an operating system 616 (e.g., Mac OS®, Windows®, Linux, etc.), a network communication module 618, a browser 620 (e.g., Microsoft® Internet Explorer, Netscape®, Safari®, etc.) and secure access instructions 622.

The operating system 616 can be multi-user, multiprocessing, multitasking, multithreading, real-time and the like. The operating system 616 performs basic tasks, including but not limited to: recognizing input from input devices 610; sending output to display devices 604; keeping track of files and directories on computer-readable mediums 612 (e.g., memory or a storage device); controlling peripheral devices (e.g., disk drives, printers, network interface 608, etc.); and managing traffic on the one or more buses 614. The network communications module 618 includes various components for establishing and maintaining network connections (e.g., software for implementing communication protocols, such as TCP/IP, HTTP, Ethernet, etc.). The browser 620 enables the user to search a network (e.g., Internet) for information (e.g., digital media items). The secure access instructions 622 enables the features and processes described in reference to FIGS. 1-5. In some implementations, the unique ID 624 and cryptographic information 626 is stored on the computer-readable medium 612.

### Example Secure Access Service Architecture

FIG. 7 is a block diagram illustrating an example architecture 700 for a secure access service (e.g., secure access service 103). In some implementations, the architecture 700 generally includes a web server 702, an authentication server 704, an optional administrator console 706, a network interface 708 and a repository 114. Each of the these components can be coupled to one or more communication channels or busses 712. The architecture 700 is an example architecture and other architectures are possible, including architectures having more or fewer components.

The web server 702 can serve web pages to the communication terminal 104 as described in reference to FIG. 1. The authentication server 704 can validate unique IDs and authenticate users as described in reference to FIGS. 3 and 5. The optional administrator console 706 can be used by a website administrator to manage the secure access service. The network interface 708 can be used to interface with network 106 to facilitate communication with communication terminals. The repository 114 (e.g., SQL database) can be used to store unique IDs and other information used in the validation and authentication processes.

### Example Applications for Secure Access Service

### Secure Access to Children's Websites

Content providers dedicated to children and teens under age are concerned about the security they can provide to their members. These site owners cannot currently guarantee that the content delivered to their members is entirely free of illegal, offensive, pornographic, or otherwise inappropriate material, or that its members will not encounter inappropriate or illegal conduct from other members. When the content provider allows access to its site through a secure access service, it is the responsibility of the parents to proceed with the enrollment of their children on the content provider's Home Page by providing: a Login ID, a Password and a MAC address of a device/peripheral recorded on a worldwide database as the property of their child. After initial registration, as described in reference to FIGS. 2-4, the child can connect to the site on a predetermined schedule set by her parents, under the sole condition that her device (e.g., a mobile phone or wristwatch) is within a specified transmission range of the communication terminal (e.g., personal computer).

### Secure Access to Mailboxes

People that are not technically savvy will sometimes ask help from a third party to setup their electronic mailboxes. To do this, they need to give the third party (e.g., an IT consultant) information pertaining to their Internet Service Provider (e.g., login name and password). When accessing their email, which has been protected by their device through the secure access service, the reviewing of their messages will only be possible under the condition that their device or peripheral, the unique ID of which is recorded in the repository 114, is within the specified transmission range of the communication terminal.

### Secure Access to Pornographic Websites & Hosting of Same

Hosting companies are often reluctant to host pornographic sites on their servers because they could potentially face lawsuits. However, pornographic websites are a primary source of revenue on the Internet. The secure access service can secure access to pornographic websites more safely. Only members that have been identified as adults would be allowed to access such sites. A contract may stipulate that the content provider will only allow access to its site through the secure access service. For example, the user must register on a secured Home Page of a website operated by the secure access service by creating a login ID and password, and connecting a device to the communication terminal, so the site can read the device's MAC address and confirm whether or not the user is old enough to be granted access or not based on personal information stored in the repository 114.

### Lost, Stolen of Gifted Devices/Peripherals

A user who has their registered device lost or stolen can send a request to “lock” their account with the secure access service. The lock will disable the user's account, preventing the device from being used to access secure network resources.

### Pre-Owned Devices and Peripherals

When acquiring a pre-owned device, the new owner of a previously registered device may be asked to comply with certain requirements. For example, a new owner may be required to present a valid ID to the retailer that originally sold the device to register the device in the new owner's name, and/or log into the secure access service to confirm the new owner's identity with a valid credit card or other suitable form of identification.

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
detecting a device;
establishing a communication channel with the device;
receiving a unique identifier from the device over the channel, the unique identifier uniquely identifying the device;
sending the unique identifier to a secure access service;
receiving a request for information from the secure access service;
presenting the request to a user of the device;
receiving the requested information from the user of the second device;
sending the requested information to the secure access service;
receiving cryptographic information from the secure access service, the cryptographic information generated from the unique identifier and at least some of the requested information; and
providing access to a secure network resource based on the cryptographic information.

2. The method of claim 1, where detecting further comprises:
adjusting a transmission range to define a region of detection.

3. The method of claim 1, where establishing a communication channel with the device comprises establishing a connection with a Bluetooth-enabled device.

4. The method of claim 3, where receiving a unique identifier from the Bluetooth-enabled device comprises receiving a BD address from the device.

5. The method of claim 1, where receiving cryptographic information from the secure access service comprises receiving a key code or digital certificate from the secure access service.

6. The method of claim 1, where presenting the request comprises presenting the request in a web page.

7. A computer-implemented method comprising:
establishing a communication channel with a communication terminal;
receiving a unique identifier over the communication channel;
sending an information request to the communication terminal;
receiving the requested information from the communication terminal;
generating cryptographic information using the requested information and the unique identifier; and
sending the cryptographic information to the communication terminal.

8. The method of claim 7, further comprising:
storing the unique identifier in a repository.

9. The method of claim 7, where generating cryptographic information comprises generating a key code or digital certificate using the requested information and the unique identifier.

10. A computer-implemented method comprising:
receiving user input requesting access to a secure network resource;
responsive to the input, establishing a communication channel with a communication terminal;
sending a unique identifier to the communication channel; and
receiving cryptographic information from the communication terminal, the cryptographic information generated from the unique identifier and information associated with the user.

11. The method of claim 10, further comprising:
storing the cryptographic information.

12. A computer-implemented method comprising:
receiving a request to access a secure network resource;
responsive to the request, establishing a communication channel with a communication terminal;
receiving a unique identifier associated with a device and cryptographic information associated with a user of the device;
validating the device using the unique identifier;
authenticating the user using the cryptographic information; and
responsive to a positive validation and authentication, allowing the device access to the secure network resource.
